(19) United States
(12) Patent Application Publication
(10) Pub. No.: US 2010/0313186 A1
(43) Pub. Date: Dec. 9, 2010

(54) DEVELOPER-MANAGED DEBUGGER DATA RECORDS

(75) Inventors: Richard G. Chiodo, Bothell, WA (US); Snohomish P. Griesmer, Snohomish, WA (US); Elena Monica Boris, Redmond, WA (US); Andrew Brian Hall, Kirkland, WA (US); Karthikeyan Sethuramasubbu, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/478,142

(22) Filed: Jun. 4, 2009

(51) Int. Cl. G06F 9/44

(52) U.S. Cl. 717/131

(57) ABSTRACT

A developer analysis record supports debugging. One developer analysis record contains a copy of a debuggee source code expression including one or more variables. An expression location in the record specifies the location of the expression within debuggee source code, and an expression scope specifies the scope of the expression within the source code. Developer comments about the expression may be stored in the record, distinct from source code and free from programming language syntax restrictions. The developer analysis record can be stored by a developer during one debugger session and then retrieved by the same or another developer during a later debugger session. The developer analysis record can be displayed and updated in a floating window, such as a tear-off floating datatip window.

### BACKGROUND

A debugger is a computer program used to test and debug other programs, which are referred to as debuggee programs or simply as “debuggees”. Source-level debuggers show a developer debuggee source code during debugging. A debugger generally provides a software developer with some control over debuggee execution, such as pausing execution to examine the debuggee's variables and other internal state information, stepping through debuggee code line-by-line, and setting a breakpoint to stop debuggee execution when a specified condition occurs within the debuggee. Some debuggers also allow a developer to modify the debuggee's internal state during debugging by setting variables, instead of merely observing the internal state.

### SUMMARY

Some embodiments facilitate debugging by providing a developer analysis record containing information to support developer analysis of a debuggee. For example, a developer analysis record may contain a copy of a debuggee source code expression, such as a variable or a statement including one or more variables. An expression location in the record specifies a location of the expression within debuggee source code. An expression scope specifies a scope of the expression within the debuggee source code, using scope identifiers such as function identifiers, class identifiers, namespace identifiers, and/or module identifiers. The developer analysis record may also contain a developer comment regarding the expression. Unlike source code comments, the developer analysis record comment is external to the debuggee source code and is not subject to programming language syntax restrictions. The developer analysis record can be stored by a developer during one debugger session and then retrieved by the same or another developer during a later debugger session. The developer analysis record can be displayed and updated in a floating window, which in some cases can be a tear-off floating window. As debugging proceeds, the floating window displays an evaluation of the expression when the expression is in scope, and an out-of-scope indication when the expression is not within scope.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, a debugger, at least one debuggee including source code, and other items in an operating environment which may be present on multiple network nodes, and also illustrating configured storage medium embodiments;

FIG. 2 is a block diagram illustrating an example architecture; and

FIG. 3 is a flow chart illustrating steps of some method and configured storage medium embodiments.

### DETAILED DESCRIPTION

Overview

During debugging of an application, a user of the Microsoft Visual Studio® development environment can hover a mouse-driven cursor over a variable to show the value of that variable at run time. At this point the user could benefit from some or all of the following information: (a) the location at which the variable is defined in the source code, since multiple variables may have the same name or similar names; (b) the scope of the variable, since one may ask when the displayed variable X goes out of scope and a different variable also named X comes into scope; (c) which of several same-named or similarly-named variables X is this current variable X; (d) what values the developer, or another developer, expected the variable to have while debugging; (e) what values the developer, or another developer, saw the variable have while debugging.

Some embodiments described herein provide some or all of the foregoing information, in a developer analysis record which is displayed in a floating window. In some embodiments, the developer can tear-off the floating window, allowing the developer to use the mouse for other informational and/or navigational effects without necessarily losing access to the comments and other information shown in the developer analysis record.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

Without a context, “comments” could refer to source code comments or to developer analysis record comments. Source code comments are part of a debuggee program's source code, are parsed during compilation, and are subject to programming language syntax restrictions. Developer analysis record comments are external to a debuggee source code, are not parsed during compilation, and are not subject to programming language syntax restrictions. Unless a context expressly refers to source code comments, the term “comments” used herein refers to developer analysis record comments.

Throughout this document, use of the optional plural “(s)” means that one or more of the indicated feature is present. For example, “comment(s)” means “one or more comments” or equivalently “at least one comment”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

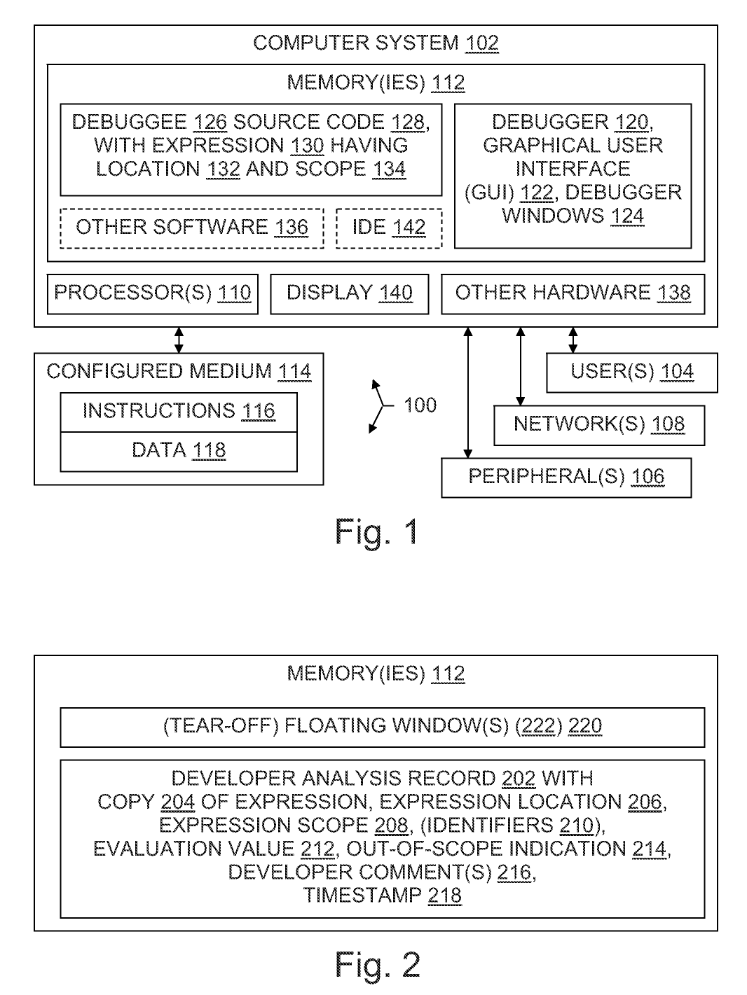

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more memories 112. The memories 112 may be volatile, non-volatile, fixed in place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. “Source code” refers to code that is human-readable, e.g., code written in a programming language such as C#, Java, or assembly. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed as discussed herein, e.g., by evaluation, scoping, locating, commenting, debugging, execution, modification, display, creation, loading, and/or other operations.

Memories 112 may be of different physical types. A debugger 120 with a graphical user interface (GUI) 122 is present. The debugger GUI provides familiar windows 124 such as a watch window, call stack window, and source code window. The debugger 120 can be used to help debug one or more debuggees 126. A debuggee has source code 128, which includes code fragments containing expressions 130. “Expression” is a term used here in a manner consistent with the term's use in programming language syntax definitions; an “expression” is a variable or a combination of variable(s) and operation(s) which can be evaluated to yield a value in the form of a number, a string, an array of values, a linked structure of values, or the like. An expression has a location 132 in the source code 128, and a visibility scope 134 within the source code 128.

Other software 136 may also be present, such as compiler(s), networking tool(s), email, word processor and other business tools, databases, and so on. Items shown in the Figures may reside partially or entirely within one or more memories 112, thereby configuring those memories. An operating environment may also include other hardware 138, such one or more screens, monitors, or other display(s) 140, as well as buses, power supplies, and accelerators, for instance.

A given operating environment 100 may include an Integrated Development Environment (IDE) 142 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs.

Some items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. In some embodiments, a developer analysis record 202 in an enhanced debugger 120 includes a copy 204 of an expression 130. The developer analysis record 202 has an expression location 206 which specifies the location 132 of the original expression 130 in the debuggee source code 128, and an expression scope 208 which specifies the visibility scope 134 of the original expression 130 in the debuggee source code 128. Location and/or scope may be specified, for example, using identifiers 210 such as a function identifier, a class identifier, a namespace identifier, a module identifier. Location and/or scope may also, or alternately, be specified using filename(s) and/or line number range(s) (a single line is a special case of a line number range).

In some embodiments, a developer analysis record 202 contains an evaluation value 212 of the expression 130 when the expression is in scope during debugging, and contains an out-of-scope indication 214 when the expression is not within scope. For example, if the expression is simply a variable X, then the developer analysis record 202 contains the current value of X (which could be random if X was not initialized) while X is in scope, and the record contains a flag or enumeration or text indicating “out of scope” or “not currently visible”, or the like, while X is out of scope.

In some embodiments, a developer analysis record 202 contains one or more developer comments 216. Comments 216 are free-form, unlike source code comments which treat certain characters as delimiters based on the syntax of the programming language in which the source code is written. For example, a developer comment could remark that on such-and-such a date (or in version such-and-such) the value of expression Y was observed to be Value-1 whereas the value expected was Value-2, and perhaps the cause of this is in procedure P of module M.

In some embodiments, a developer analysis record 202 contains a timestamp 218 indicating when the record was created, and/or when it was last modified. Individual developer comments 216 may have respective individual timestamps 218.

In some embodiments, one or more of the data items 204-218 of a developer analysis record 202 are displayed to user(s) 104 in a floating window 220 in the enhanced debugger 120. In particular, some floating windows 220 which display developer analysis record 202 contents are tear-off floating windows 222.

With respect to the foregoing, debuggee source code is source code in a format that can be productively processed by a compiler. This does not require that the source code compile without errors. One can distinguish comments 216 in developer analysis records 202 from conventional comments embedded in source code 128. Conventional comments are seen by a compiler (possibly by a preprocessor) in the first stage of a compilation, whereas developer comments 216 are external to the source code seen by a compiler.

In some embodiments, a developer analysis record 202 includes data underlying pinnable and floating debugger datatips. Note also that the information in items 206-218 presented to a user can be distinguished from the user interface 122 mechanism(s) (e.g., tear-off floating window mechanisms, mouse buttons, menu and other GUI color schemes) that are used to present the developer analysis record 202 information.

With reference to FIGS. 1 and 2, some embodiments provide a computer system 102 with a logical processor 110 and a memory 112 configured by circuitry, firmware, and/or software to transform debugging contextual data to facilitate debugging by associating developer comments with specific state and context data about a debuggee expression. In some cases, that contextual data persists between debugging sessions.

For example, in some embodiments a developer analysis record 202 configures memory 112 in operable communication with the logical processor 110 in a system 102. The developer analysis record 202 contains information to support developer analysis of a debuggee. In particular, the developer analysis record 202 contains a copy 204 of an original debuggee source code expression 130, with an expression location 206 specifying a location within a debuggee source code of the original debuggee source code expression and an expression scope 208 specifying a scope within the debuggee source code of the original debuggee source code expression. In general, the scope extends beyond the original debuggee source code expression itself, because the expression is a code fragment whose context is other code. The developer analysis record 202 may also contain a developer comment 216 regarding the expression. The comment is external to the debuggee source code, unlike conventional comments.

In some embodiments, the expression location 206 specifies a location in the source code at which a variable of the expression 130 is defined. Variable definitions and other aspects of expressions can be pinned to the source code 128 in some embodiments, so that their location 206 is updated after lines of code are added/deleted/moved in the source code. For example, the location 206 could be implemented as a {filename, file current timestamp, line number(s), location timestamp} tuplet, which is initially set when the record 202 is created, and is updated by parsing to re-acquire the expression's current location if the file's current timestamp is newer than the location's timestamp.

In some embodiments, an enhanced debugger configures a portion of the memory 112. The developer comment(s) 216 regarding the expression are displayed within the debugger and also configure the display 140.

In some embodiments, the expression scope 208 specifies one, two, or more of the following: a range of lines within the debuggee source code 128, a function identifier, a class identifier, a namespace identifier, a module identifier, a filename. Similarly, the expression location 206 contains one or more of the foregoing items in some embodiments.

In some embodiments, the developer analysis record 202 contains an evaluation value 212 of the expression. Evaluation may be performed using familiar debugger mechanisms, adapted for communication with the developer analysis record 202.

In some embodiments, the system 102 is configured by a persistent copy of the developer analysis record 202, namely, a copy which persists between debugger sessions. For example, the record 202 may be stored in a file in persistent memory 112 such as a hard disk. In some embodiments, the record 202 is stored as part of a Microsoft Program Database (PDB) file. PDB files are created by a compiler. Information can be extracted from a PDB file using the publically available Microsoft Debug Interface Access (DIA) interfaces.

In some embodiments peripherals 106 such as human user I/O devices (screen, keyboard, mouse, tablet, microphone, speaker, motion sensor, etc.) will be present in operable communication with one or more processors 110 and memory 112. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Methods

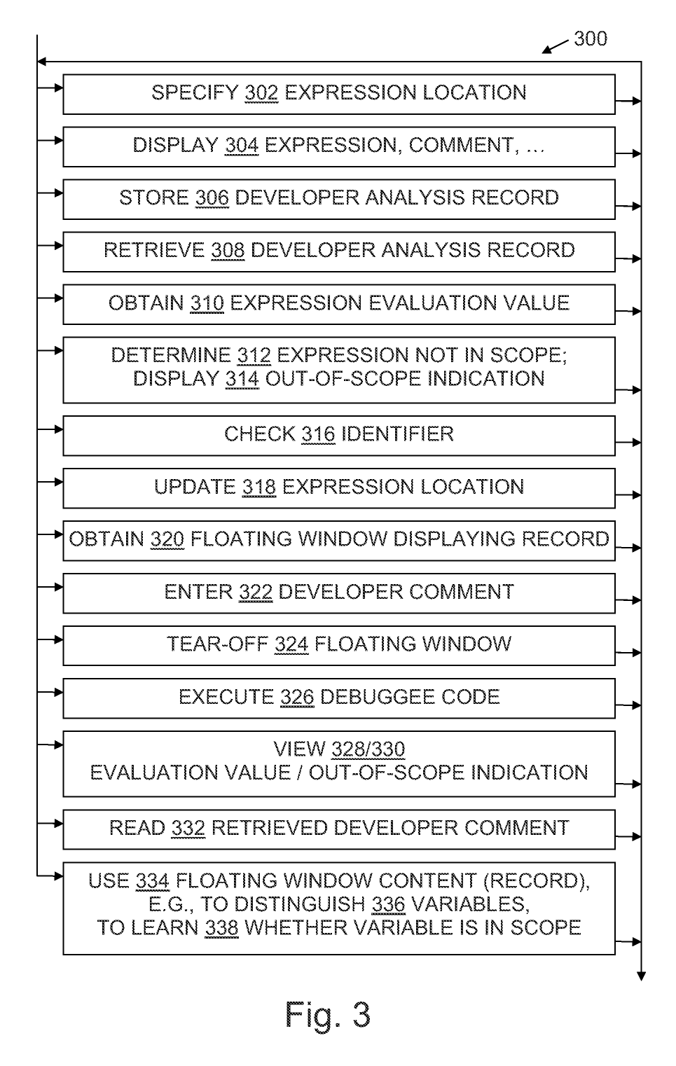

FIG. 3 illustrates some method embodiments in a flowchart 300. Methods shown in the Figures may be performed in some embodiments automatically, e.g., by an enhanced debugger 120 manipulating developer analysis records 202 under control of a script requiring little or no user input. Methods may also be performed in part automatically and in part manually unless otherwise indicated. In a given embodiment zero or more illustrated steps of a method may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During an expression location specifying step 302, an embodiment places (initializes or updates) an expression location 206 in a developer analysis record 202. Step 302 may be accomplished using debugger, compiler, IDE and/or other mechanisms for determining the location of a selected source code fragment, for example, adapted for communication with the developer analysis record 202.

During a displaying step 304, an embodiment displays information from a developer analysis record 202, such as an expression 130 or a comment 216, in a floating window 220 or a tear-off floating window 222. Step 304 may be accomplished using debugger GUI 122, or another presentation layer mechanism, for example, adapted for communication with the developer analysis record 202.

During a developer analysis record storing step 306, an embodiment stores a persistent copy of a developer analysis record 202. Step 306 may be accomplished using familiar stream I/O, file I/O, network I/O, and/or other mechanisms, for example, adapted for communication with the developer analysis record 202 through a PDB file format, an XML format, or another format, and a persistent memory 112.

During a developer analysis record retrieving step 308, an embodiment retrieves from storage a persistent copy of a developer analysis record 202. Step 308 may be accomplished using mechanisms and formats used in step 306, for example.

During an expression evaluation value obtaining step 310, an embodiment obtains an evaluation value of an expression 130. Step 310 may be accomplished using debugger 120 mechanisms, for example, adapted for communication with the developer analysis record 202.

During an expression scope determining step 312, an embodiment determines whether an expression 130 copied in a developer analysis record 202 is currently within scope, given the current program counter or other execution point of a debuggee within an enhanced debugger. Step 312 may be accomplished using compiler scoping mechanisms, IDE scoping mechanisms, or other mechanisms for determining whether variable(s) of a given expression are visible at a given point in program code, for example, adapted for communication with the developer analysis record 202.

During an out-of-scope displaying step 314, an embodiment displays a graphical and/or textual indication 214 that at least one variable of an expression of a developer analysis record 202 is currently out of scope, based on a result of scope determining step 312. Step 314 is a particular example of displaying step 304. Step 314 may be accomplished using debugger GUI 122, for example, adapted for communication with the developer analysis record 202.

During an identifier checking step 316, an embodiment checks one or more identifiers 210, comparing the current debuggee execution point identifiers with the record 202 identifiers to help determine 312 whether an expression is in scope.

During an expression location updating step 318, an embodiment updates an expression location in a record 202, in response to an update to the corresponding source code 128 that may have changed the expression's location.

During a floating window obtaining step 320, a user of an embodiment obtains a floating window 220 or a tear-off floating window 222 in an enhanced debugger. The window 220, 222 obtained 320 displays one or more of the items 206-216. Step 320 may be accomplished using an embodiment that performs step 306, for example, and/or otherwise manages developer analysis records 202 that contain one or more of the items 206-216.

During a developer comment entering step 322, a user of an embodiment enters a developer comment 216 for storage (temporary or persistent) in a developer analysis record 202. Step 322 may be accomplished using debugger GUI 122, for example, adapted for communication with the developer analysis record 202.

During a window tearing-off step 324, a user of an embodiment creates a tear-off window 222 populated with one or more of the items 206-216. Step 324 may be accomplished using a GUI in an embodiment that manages developer analysis records 202 that contain one or more of the items 206-216.

During a debuggee executing step 326, a user of an embodiment causes execution of at least one instruction of a debuggee program. Step 326 may be accomplished using a debugger 120, for example.

During an evaluation value viewing step 328, a user of an embodiment views an evaluation value 212 in a window 220, 222. Step 328 may be accomplished using a GUI in an embodiment that manages developer analysis records 202 that contain evaluation value(s) 212.

During an out-of-scope viewing step 330, a user of an embodiment views an out-of-scope indication 214 in a window 220, 222. Step 330 may be accomplished using a GUI in an embodiment that manages developer analysis records 202 that contain out-of-scope indication(s) 214.

During a developer comment reading step 332, a user of an embodiment reads a developer comment 216 in a window 220, 222. Step 332 may be accomplished using a GUI in an embodiment that manages developer analysis records 202 that contain developer comment(s) 216.

During a floating window using step 334, a user of an embodiment creates, reads or views, writes or enters, and/or otherwise uses a window 220, 222. Step 334 may be accomplished using one or more of steps 320-324, 328-332, for example.

During a variable distinguishing step 336, a user of an embodiment uses scoping and/or other information displayed from a developer analysis record 202 to distinguish between two or more variables having the same or similar names. Step 336 may be part of step 334, for example.

During a scope learning step 338, a user of an embodiment uses scoping and/or other information displayed from a developer analysis record 202 to learn the scope of one or more variables of an expression 130. Step 338 may be part of step 334, for example.

The foregoing steps and some of their interrelationships are discussed further below, in connection with various embodiments.

Some embodiments provide a method for facilitating software debugging. The method includes specifying 302 in a developer analysis record 202 an expression location 206 which locates a source code expression 130 within a debuggee source code 128, and storing 306 in the developer analysis record a developer comment 216 regarding the expression. In some embodiments, the method includes automatically updating 318 the expression location after a change in the debuggee source code. The method may also include displaying 304 the source code expression and the developer comment in a floating window 220, 222 in an enhanced debugger. In some embodiments, the floating window of the displaying 304 step(s) is a tear-off floating window 222.

In some embodiments, the method includes obtaining 310 an evaluation value 212 of the source code expression, and displaying 304 the evaluation value in the floating window in the debugger. In some cases, the method determines 312 that the source code expression is not presently within scope during debugging, and displays 304, 314 an out-of-scope indication 214 in the floating window in the enhanced debugger. In some embodiments, determining 312 that the source code expression is not within scope includes checking 316 at least one of the following identifiers 210: a function identifier, a class identifier, a namespace identifier, a module identifier.

In some embodiments, the method includes storing 306 a persistent copy of the developer analysis record 202, namely, a copy which persists between debugger sessions. Storing can be accomplished without a cut-and-paste to a word processor file. Stored developer analysis record(s) 202 can be subsequently retrieved 308, by the same developer and/or by a different developer.

Some embodiments provide a method performed by a developer during software debugging. Such methods correspond generally with methods performed by an embodiment, such as an enhanced debugger. A method performed by a developer may include, for example, obtaining 320 in a debugger graphical user interface a floating window 220, 222 which displays a source code expression of a debuggee source code. For instance, the developer may tear-off 324 the floating window from a debugger datatip. The expression is a code fragment, in some cases no larger than a single source code statement. The developer also enters 322 into the floating window a developer comment 216 regarding the expression.

In some methods, the developer executes 326 (causes execution of) debuggee code. In response to the execution, the developer may then view 328 in the floating window a current evaluation value of the source code expression, and/or view 330 an out-of-scope indication for the source code expression, depending on what variable(s) of the expression are in scope, and whether evaluation is automatically performed to update the floating window contents.

In some methods, one developer reads 332 another developer's comment 216, after it is retrieved 308 from a storage location outside the debuggee source code during a debugger session. In some, a developer uses 334 the floating window to distinguish 336 variables from one another and/or to learn 338 whether a variable is currently in scope while stepping through the debuggee source code.

Configured Media

Some embodiments include a configured computer-readable storage medium 114, which is an example of a memory 112. Memory 112 may include disks (magnetic, optical, or otherwise), RAM, EEPROMS or other ROMs, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using items such as developer analysis records 202 and/or enhanced debuggers or other software that manages records 202, in the form of data 118 and instructions 116, read from a removable medium 114 and/or another source such as a network connection, to form a configured medium. The configured memory 112 is capable of causing a computer system to perform method steps for transforming data through developer analysis record-keeping as disclosed herein. FIGS. 1 through 3 thus help illustrate configured storage media embodiments and method embodiments, as well as system and method embodiments. In particular, any of the method steps illustrated in FIG. 3, or otherwise taught herein, may be used to help configure a storage medium to form a configured medium embodiment.

### ADDITIONAL EXAMPLES

Additional details and design considerations are provided below. As with the other examples herein, the features described may be used individually and/or in combination, or not at all, in a given embodiment.

In some embodiments, variables are shortened expressions. For instance, a variable might be X, while an expression can be X or X.Y or X.GetColor( ). Debugger datatips support both variables and expressions. Variables have both scope and definition. An arbitrary expression not found in the source code does not necessarily have a scope or definition. However, a copy of an expression that is in the source code can be defined to have both scope and definition. The expression copy's definition is given in the line(s) of source code from which the expression was copied into the developer analysis record 202. The expression copy's scope is at least those definitional line(s), and may extend further. Some embodiments define the scope of an expression copy as the intersection of the scope of all variables used in the expression copied. Some embodiments track scope of each such variable individually.

Some embodiments provide developers with answers to one or more questions as follows.

“Where was this variable defined? I see variable X in a floating window but I'm not sure which X I'm seeing.” Some embodiments address such questions by computing where each variable of an expression is defined in the source code, and displaying that location 206 information to the user. Some embodiments compute the location of a variable by searching for the variable in a parse tree of a file. Some embodiments use the Program Database (PDB) information for a module.

“How long with this variable be in use? I see X in a floating window, but when will the other X be used?” Some embodiments address such questions by computing the scope of each variable of an expression, based on the current execution point and the source code, and displaying that scope 208 information to the user. In some embodiments, the same information used to determine the definition location of a variable can also be used to determine how long a variable is in scope.

“Which X am I looking at?” Such questions are addressed in some embodiments by determining and displaying the scope of a variable. When some embodiments create a floating and/or pinned datatip window 220, 222, the function, class, namespace, and/or module identifiers 210 of an expression 130 variable will be saved, as well as the position within the file the cursor was hovering over. Such information can uniquely identify a variable. Such information can also be used in some embodiments to indicate when a variable X is out of scope, because the X added to a datatip window 220, 222 is specific to a certain scope. In some embodiments, debugger datatips are enhanced to allow users to create tear-off tips that remain visible even after the mouse is moved or the user continues to execute a debuggee. These tear-off tips also support pinning to a source file so that the next time a user debugs this same file, the user can see the expressions used the last time the user looked at this file. Comments, expressions, and other parts of a record 202 can be exported and imported as a data stream in some embodiments.

“What are the expected values of X? Did Pat ever debug this before and get different results?” Such questions are addressed in some embodiments through the addition of comments 216 to saved expressions.

“Can I see this value of X without using this floating window? I need the mouse for something else.” Some embodiments address such requests by creating tear off floating windows 222 (which persist, for instance after hitting F5 or moving the mouse) and/or by pinning expressions into the source file using an expression location 206.

“Can I save this floating X for looking at later by either me or Pat?” Some embodiments address such requests by allowing the user to save expressions (e.g., variables) and read them in later, using storing 306 and retrieving 308 steps. With some embodiments, developer comments 216 are added to expressions and stored in a solution options file.

Some embodiments help developers determine and/or assess one or more of the following: the uniqueness of an expression, the definition of an expression, the definition of a variable, the definition of another expression, the scope of a variable, the scope of another expression, comments from other developers in a runtime context with associated source code, pinning comments to source code and reacting to source code changes by updating the comment's associated location to maintain the pinning.

With regard to determining scope, consider two different X's shown below:

| | |
|---|---|
| 3 | namespace MyNameSpace |
| 4 | { |
| 5 | public class Bar |
| 6 | { |
| 7 | public void Foo(int x) // local variable X |
| 8 | { |
| 9 | if (_bar) |
| 10 | { |
| 11 | int x = 4; //sub-scoped X |
| 12 | |
| 13 | //... |
| 14 | } |
| 15 | } |
| 16 | } |
| 17 | } |

In some embodiments, information from the record 202 is used when the window 220, 222 is displayed in the debugger GUI, allowing a user to see where a variable is defined and what the variable's scope is, and hence to determine the lifetime and relevance of a particular variable. For example, in some embodiments the following information is noted for the foregoing source code in the expression scope 208 and/or the expression location 206 (one data set may serve as both scope 208 and location 206) to determine the uniqueness of a variable and construct the appropriate window 220, 222 for the user:
Defining line: (line 7 for outer X, line 11 for inner X)
Scope (lines 8 through 15 for the outer X, lines 10 through 14 for the inner X)
Function (“Foo” for both Xs)
Class (“Bar” for both Xs)
Namespace (“MyNamespace” for both Xs)
Module (same for both Xs)
FileName (same for both Xs)

One released public implementation supports developer comments 216 in floating datatip windows.

In one embodiment, an enhanced debugger includes familiar windows 124, such as a watch window, a call stack window, and a source code window. A floating datatip window 220 menu in the source code window offers menu items such as: Copy, Copy Expression, Copy Value, Edit Value, Hexadecimal Display, Add Expression, and Remove Expression. If a developer chooses Add Expression from the menu, the enhanced debugger GUI displays a window 220 with an expression and an associated “<not evaluated yet>” out-of-scope indication 214 or an evaluation value 212. The window 220 includes a menu icon labeled “Expand to see comments” which leads to a text box containing the initial text “Type a comment here.” Comments 216 can be entered in the text box. As the developer step forward through debuggee code, the expression value 212/214 in the floating datatip window is updated, showing a current value 212 and then as execution continues showing an indication 214 “The name V does not exist in the current context.”

### CONCLUSION

Although particular embodiments are expressly illustrated and described herein as methods, as configured media, or as systems, it will be appreciated that discussion of one type of embodiment also generally extends to other embodiment types. For instance, the descriptions of methods in connection with FIG. 3 also help describe configured media, and help describe the operation of systems and manufactures like those discussed in connection with other Figures. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A system comprising:
at least one logical processor;
a memory in operable communication with the at least one logical processor;
a developer analysis record configuring a portion of the memory and containing at least the following information to support developer analysis of a debuggee:
a copy of an original debuggee source code expression,
an expression location specifying a location within a debuggee source code of the original debuggee source code expression,
an expression scope specifying a scope within the debuggee source code of the original debuggee source code expression, the scope extending beyond the original debuggee source code expression, and
a developer comment regarding the expression, the comment being external to the debuggee source code.

2. The system of claim 1, further comprising a debugger configuring a portion of the memory, and a display, and wherein the developer comment regarding the expression is displayed within the debugger and configures the display.

3. The system of claim 1, wherein the expression scope specifies at least two of the following: a range of lines within the debuggee source code, a function identifier, a class identifier, a namespace identifier, a module identifier, a filename.

4. The system of claim 1, wherein the developer analysis record contains an evaluation value of the expression.

5. The system of claim 1, wherein the developer analysis record contains a timestamp.

6. The system of claim 1, further comprising a display configured by a tear-off floating window which displays the developer analysis record.

7. The system of claim 1, further comprising a persistent copy of the developer analysis record, namely, a copy which persists between debugger sessions.

8. A computer-readable medium configured with data and instructions for performing a method for facilitating software debugging, the method comprising the steps of:
specifying in a developer analysis record an expression location which locates a source code expression within a debuggee source code;
displaying the source code expression in a floating window in a debugger;
storing in the developer analysis record a developer comment regarding the expression; and
displaying the developer comment in the floating window in the debugger.

9. The configured medium of claim 8, wherein the floating window of the displaying steps is a tear-off floating window.

10. The configured medium of claim 8, wherein the method further comprises obtaining an evaluation value of the source code expression, and displaying the evaluation value in the floating window in the debugger.

11. The configured medium of claim 8, wherein the method further comprises determining that the source code expression is not within scope during debugging, and displaying an out-of-scope indication in the floating window in the debugger.

12. The configured medium of claim 11, wherein determining that the source code expression is not within scope comprises checking at least one of the following: a function identifier, a class identifier, a namespace identifier, a module identifier.

13. The configured medium of claim 8, wherein the method further comprises storing a persistent copy of the developer analysis record, namely, a copy which persists between debugger sessions.

14. The configured medium of claim 8, wherein the method further comprises automatically updating the expression location after a change in the debuggee source code.

15. A method performed by a developer during software debugging, the method comprising the steps of:
obtaining in a debugger graphical user interface a floating window which displays a source code expression of a debuggee source code, the expression being a code fragment no larger than one source code statement; and
entering into the floating window a developer comment regarding the expression.

16. The method of claim 15, wherein the obtaining step comprises tearing-off the floating window.

17. The method of claim 15, wherein the method further comprises executing debuggee code and then viewing a current evaluation value of the source code expression in the floating window in response to the executing step.

18. The method of claim 15, wherein the method further comprises executing debuggee code and then viewing an out-of-scope indication for the source code expression in the floating window in response to the executing step.

19. The method of claim 15, wherein the method further comprises reading a second developer comment and an associated second source code expression from a location outside the debuggee source code during a debugger session, without having written the second developer comment during the debugger session.

20. The method of claim 15, wherein the source code expression includes at least one variable, and the method further comprises using the floating window by performing at least one of the following:
distinguishing a first variable having a name from a second variable having the same name;
learning whether a variable is currently in scope while stepping through the debuggee source code.
